(19) United States
(12) Patent Application Publication
(10) Pub. No.: US 2014/0089846 A1
(43) Pub. Date: Mar. 27, 2014

(54) INFORMATION PROCESSING APPARATUS, INFORMATION PROCESSING METHOD, AND INFORMATION PROCESSING PROGRAM

(71) Applicant: Sony Corporation, Tokyo (JP)

(72) Inventors: Kouji Ogura, Kanagawa (JP); Yutaka Hasegawa, Kanagawa (JP); Masato Kajimoto, Chiba (JP); Masashi Kimoto, Tokyo (JP)

(73) Assignee: SONY CORPORATION, Tokyo (JP)

(21) Appl. No.: 14/017,750

(22) Filed: Sep. 4, 2013

(30) Foreign Application Priority Data
Sep. 24, 2012 (JP) 2012-209655

(51) Int. Cl. G06F 3/0484

(52) U.S. Cl. CPC G06F 3/04845
USPC 715/799

(57) ABSTRACT

An information processing apparatus including a display processing unit, an update unit, a vibration unit, a setting unit, and a controller. The display processing unit is configured to display, on a display unit, at least a part of a pathological image as a display area. The update unit is configured to accept an instruction from a user to move the display area on the pathological image and update a position of the display area displayed on the update unit. The vibration unit is capable of causing a vibration. The setting unit is configured to set a vibration area to cause a vibration by the vibration unit on the pathological image. The controller is configured to control the vibration unit to vibrate when a positional relationship between the set vibration area and the display area satisfies a predetermined relationship.

### CROSS REFERENCE TO RELATED APPLICATIONS

The present disclosure contains subject matter related to that disclosed in Japanese Priority Patent Application JP 2012-209655 filed in the Japan Patent Office on Sep. 24, 2012, the entire content of which is hereby incorporated by reference.

### BACKGROUND

The present disclosure relates to an information processing apparatus, an information processing method, and an information processing program with which control is executed when observing an image obtained by a microscope in fields of medical care, pathology, materials, and the like.

In the fields of medical care, pathology, and the like, there is proposed a system that is used for doctors, pathologists, and the like to examine, based on a digital image (pathological image) obtained by digitizing an image on biological cells, tissues, organs, and the like that have been obtained by an optical microscope, the tissues and the like and diagnose patients.

For example, in a method disclosed in Japanese Patent Application Laid-open No. 2009-37250 (hereinafter, referred to as Patent Document 1), an image optically obtained by a microscope is digitized by a CCD (Charge Coupled Device)-equipped video camera, and the obtained digital signal is input to a control computer system so as to be visualized on a monitor. A pathologist looks at the image displayed on the monitor and performs an examination and the like (see, for example, paragraphs (0027) and (0028) and FIG. 5 of Patent Document 1). Such a system is generally called virtual microscope.

### SUMMARY

Incidentally, in a virtual microscope of the related art as that disclosed in Patent Document 1, when a user moves a display range of a pathological image or zooms in on or out of the image, the user repeats an operation of dragging a mouse or rotating a wheel, for example. However, the pathological image handled by the virtual microscope is an enormous image having a size of 50×50 (Kpixel: Kilo-pixel), and thoroughly observing such an image has been a troublesome task for the user. In particular, since a pathologist performs such a task all day, the troublesome task causes a stress, and thus a change in pathological tissues that is to be found essentially may be overlooked to lead to a misdiagnosis.

Further, in an image diagnosis that uses a pathological image, an annotation is added to the image for indicating a position that needs to be focused within the image (e.g., position of cancer cell). In a task of double-checking the pathological image by a plurality of pathologists or getting a second opinion from them, the annotation added to the pathological image also needs to be focused upon. However, when a user is observing the pathological image on a screen of a viewer while panning the image at a high speed or when the annotation is unnoticeable due to a contrast between a color of the annotation and a color of the background image, the annotation may be overlooked. In addition, since an annotation added to a pathological image displayed at a high display magnification is displayed in a small size when the pathological image is observed at a low display magnification, the annotation in this case may also be overlooked.

In view of the circumstances as described above, there is a need for an information processing apparatus, an information processing method, and an information processing program with which an operability of a UI (User Interface) when observing a pathological image can be improved using a vibration.

(1) According to an embodiment of the present disclosure, there is provided an information processing apparatus including: a display processing unit configured to display, on a display unit, at least a part of a pathological image as a display area; an update unit configured to accept an instruction from a user to move the display area on the pathological image and update a position of the display area displayed on the update unit; a vibration unit capable of causing a vibration; a setting unit configured to set a vibration area to cause a vibration by the vibration unit on the pathological image; and a controller configured to control the vibration unit to vibrate when a positional relationship between the set vibration area and the display area satisfies a predetermined relationship.

In this embodiment, the user observes various portions of the pathological image by the display processing unit and the update unit. As the vibration area preset on the pathological image by the setting unit satisfies a predetermined positional relationship with the screen of the information processing apparatus, that is, the display area as in a case where, for example, the vibration area enters the screen or comes to the center of the screen, the controller instructs the vibration unit to vibrate. The vibration area is set at a position that needs to be focused by the user. Since the user is thus prompted to focus on the vibration area, the operability of the UI can be improved.

(2) According to the embodiment of the present disclosure, the information processing apparatus may further include: an annotation setting unit configured to set an annotation in at least a partial area of the pathological image in response to an instruction from the user; and a storage configured to store positional information of an area of the set annotation. In this case, the setting unit may set the vibration area based on the stored positional information.

In this embodiment, the vibration area is set based on the positional information of the annotation area set on the pathological image. Therefore, when the annotation on the pathological image satisfies a positional relationship preset on the screen (display area), the user is notified of the annotation, with the result that the possibility of the user overlooking the annotation can be reduced.

(3) According to the embodiment of the present disclosure, in the information processing apparatus, the positional relationship may be a positional relationship in which a position that matches between the vibration area and the display area exists.

In this embodiment, when a position that matches between the vibration area and the display area exists, that is, when the vibration area is displayed on the screen, the vibration is caused. With this structure, it is possible to positively notify the user of the vibration area on the screen.

(4) According to the embodiment of the present disclosure, in the information processing apparatus, the positional relationship may be a positional relationship in which the display area comes into contact with the vibration area by the movement of the display area.

In this embodiment, since the vibration is caused at an instant the vibration area comes into contact with the screen (display area), the user can feel that the vibration area is brought into contact with a boundary of the screen.

(5) According to the embodiment of the present disclosure, in the information processing apparatus, the controller may control the vibration unit to vibrate while differentiating a vibration pattern between a time an event in which a position that matches between the vibration area and the display area exists occurs and a time an event in which the vibration area includes a center point of the display area occurs.

In this embodiment, the vibration is caused using a different vibration pattern when the display area and the vibration area are in a different positional relationship. Therefore, the user can grasp which of the positional relationships the display area and the vibration area are in by the difference in the vibration patterns.

(6) According to the embodiment of the present disclosure, in the information processing apparatus, the controller may control, when controlling the vibration unit to vibrate, the vibration unit to vibrate in a vibration pattern corresponding to the number of vibration areas set within a range of the pathological image displayed in the display area.

In this embodiment, the vibration is caused in the vibration pattern corresponding to the number of vibration areas set in a portion of the pathological image displayed in the display area when the user is observing the pathological image displayed in the display area. With this structure, the user can grasp from the vibration the number of vibration areas included in the display area.

(7) According to the embodiment of the present disclosure, in the information processing apparatus, the controller may control the vibration unit to vibrate in vibration patterns having different vibration counts, the vibration patterns corresponding to the number of vibration areas.

In this embodiment, when the user is observing the pathological image displayed in the display area, the vibration count changes according to the number of vibration areas set in the portion of the pathological image displayed in the display area. With this structure, the user can simply grasp the number of vibration areas included in the display area by counting the vibration count.

(8) According to the embodiment of the present disclosure, in the information processing apparatus, the annotation setting unit may store information on a display magnification of the pathological image used when setting the annotation in the storage in association with the positional information. In this case, the controller may control, when controlling the vibration unit to vibrate, the vibration unit to vibrate in a vibration pattern that differs depending on whether the stored information on the display magnification is the same as a display magnification used when the pathological image is displayed in the display area.

In this embodiment, the vibration pattern differs depending on whether the display magnification of the pathological image in the display area at the time the annotation is set is the same as the display magnification thereof at the time the pathological image is observed. Therefore, the user can observe the pathological image after changing the display magnification to that at the time the annotation has been set.

(9) According to the embodiment of the present disclosure, in the information processing apparatus, the setting unit may set the vibration area based on an input from the user.

In this embodiment, since the vibration area is directly set by the input from the user instead of setting it according to the setting range of the annotation, the user can freely set the vibration area within a desired range.

(10) According to an embodiment of the present disclosure, there is provided an information processing method including: displaying on a display unit, by a display processing unit, at least a part of a pathological image as a display area; accepting, by an update unit, an instruction from a user to move the display area on the pathological image and updating a position of the display area displayed on the update unit; causing a vibration by a vibration unit; setting, by a setting unit, a vibration area to cause a vibration by the vibration unit on the pathological image; and controlling, by a controller, the vibration unit to vibrate when a positional relationship between the set vibration area and the display area satisfies a predetermined relationship.
(11) According to an embodiment of the present disclosure, there is provided an information processing program that causes a computer including a vibration unit capable of causing a vibration to operate as: a display processing unit configured to display, on a display unit, at least a part of a pathological image as a display area; an update unit configured to accept an instruction from a user to move the display area on the pathological image and update a position of the display area displayed on the update unit; a setting unit configured to set a vibration area to cause the vibration by the vibration unit on the pathological image; and a controller configured to control the vibration unit to vibrate when a positional relationship between the set vibration area and the display area satisfies a predetermined relationship.

As described above, according to the embodiments of the present disclosure, the operability of the UI at the time the pathological image is observed can be improved using a vibration.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing a typical usage environment according to an embodiment of the present disclosure;

FIG. 2 is a block diagram showing a hardware structure of a viewer computer 500 according to the embodiment of the present disclosure;

FIG. 3 is a functional block diagram of an image management server 400;

FIG. 4 is a functional block diagram of the viewer computer 500;

FIG. 5 is a diagram showing a state where a rectangular vibration area enters a screen (display area) of the viewer computer 500 from above by a pan operation of a user;

FIG. 6 is a diagram showing a state where the vibration area moving from the right-hand side of the screen comes into contact with (overlaps) a center point of the screen (display area) by a pan operation of the user;

FIG. 7 is a diagram showing a state where a pointer of a viewer on the viewer computer 500 comes into contact with the vibration area;

FIG. 8 is a diagram showing an example where, in a state where the vibration area already exists in the display area, a vibration is caused twice due to the vibration area newly entering the display area;

FIG. 9 is a diagram showing an example where, when one vibration area moves out of the display area, the vibration is caused twice since there are still other vibration areas left in the display area;

FIG. 10 is a flowchart for explaining an overall flow of processing;

FIG. 11 is a flowchart showing a flow of processing of determining a vibration count and length;

FIG. 12 is a diagram showing an example of a vibration area created in a vibration area edit mode;

FIG. 13 is a diagram showing a state where an anteroposterior relationship is defined in a Z-axis direction regarding the vibration area;

FIG. 14 is a diagram showing a state where a vibration having a vibration intensity 4 is caused due to the pointer overlapping the vibration area vibrating at the vibration intensity 4;

FIG. 15 is a diagram showing a state of checking whether a position of the pointer is included within a range from the vibration area in front in the Z-axis direction; and

FIG. 16 is a flowchart for explaining a flow of processing of vibrating a controller 30.

### DETAILED DESCRIPTION OF EMBODIMENTS

Hereinafter, embodiments of the present disclosure will be described with reference to the drawings.

### First Embodiment

### Outline of Present Disclosure

As described above, an annotation added to a pathological image originally expresses a presence of the annotation itself only by visual information, and thus there has been a possibility that the annotation will be overlooked. Therefore, in an embodiment of the present disclosure, to notify a user of the annotation, a vibration is used in addition to the visual information. As a result, an effect that the possibility of overlooking the annotation is reduced can be obtained.

Specifically, as an annotation is started to be displayed in a display screen of a viewer for observing a pathological image when the user is observing the pathological image while moving it by a pan operation, a controller held by a hand of the user for performing a viewer operation is vibrated. By vibrating the controller, the user is positively notified that the annotation is being displayed in the display screen of the viewer.

It should be noted that even when the annotation is not displayed by a setting of the viewer, a vibration is caused as the undisplayed annotation enters the display screen of the viewer. Therefore, an effect that the user can grasp the presence of the annotation can be obtained.

### (Usage Environment of Present Disclosure)

First, a usage environment of the present disclosure will be described. In a pathological diagnosis, a pathologist uses a virtual slide image (pathological image) obtained by photographing a specimen using a microscope to diagnose. The pathologist uses a viewer on a viewer computer to observe a pathological image and perform an image diagnosis.

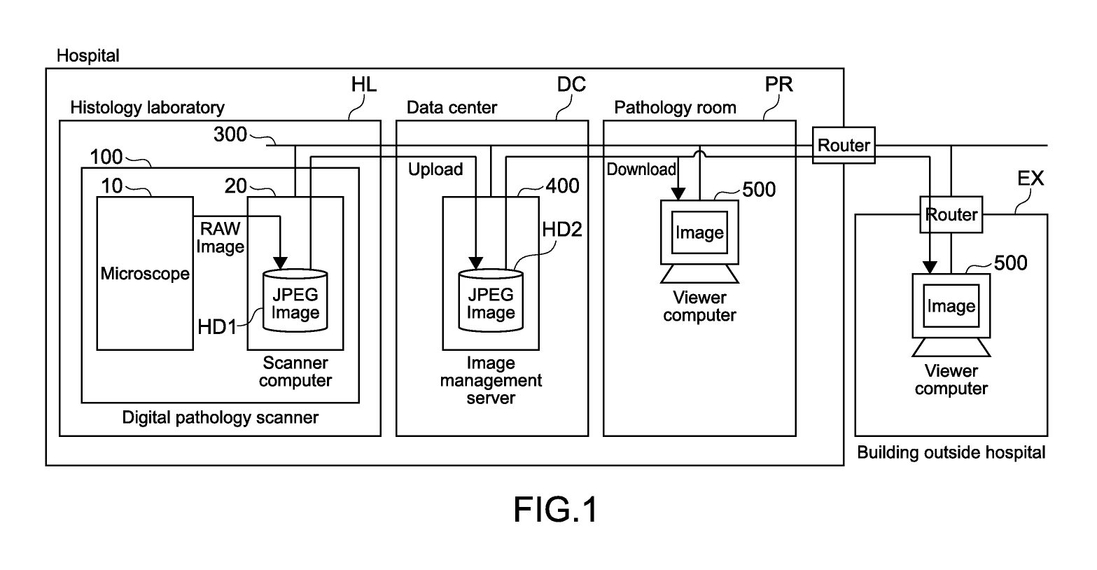

FIG. 1 is a diagram showing a typical usage environment according to an embodiment of the present disclosure.

A digital pathology scanner 100 constituted of a microscope 10 and a scanner computer 20 is set at a histology laboratory (HL) in a hospital. A RAW image photographed by the microscope 10 is subjected to image processing such as development processing, shading processing, color balance correction, gamma correction, and 8-bit processing on the scanner computer 20. After that, the image is divided into, for example, tiles of 256 pixels in matrix and converted into a JPEG (Joint Photographic Experts Group) image. After the JPEG image is compressed, the image is stored in a hard disk HD 1.

Next, the JPEG image stored in the hard disk HD1 of the scanner computer 20 is uploaded to a hard disk HD2 of an image management server 400 in a data center DC of the same hospital via a network 300.

A pathologist as an observer uses a viewer computer 500 in a pathology room PR in the hospital or a building EX outside the hospital, that is connected to the image management server 400 via the network 300, to observe the JPEG image stored in the hard disk HD2 of the image management server 400.

The pathologist uses a controller (not shown) connected to the viewer computer 500 to perform a pan operation and a zoom operation in observing the JPEG image. The controller includes a built-in vibration motor, and by operating the vibration motor, a vibration can be propagated to a hand of the pathologist observing the JPEG image while operating the controller.

### (Structure of Viewer Computer 500)

Next, a hardware structure of the viewer computer 500 will be described.

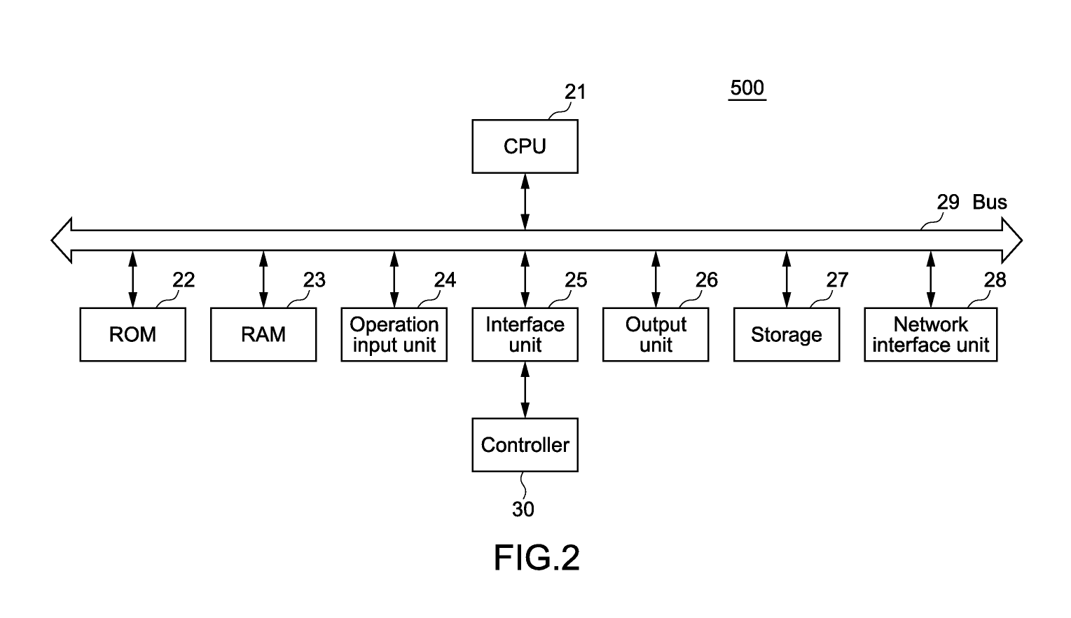

FIG. 2 is a block diagram showing the hardware structure of the viewer computer 500 according to the embodiment of the present disclosure.

The viewer computer 500 includes a CPU (Central Processing Unit) 21 for executing operational control, a ROM (Read Only Memory) 22, a RAM (Random Access Memory) 23 as a work memory of the CPU 21, and an operation input unit 24 to which an instruction corresponding to a user operation is input. The viewer computer 500 also includes an interface unit 25, an output unit 26 (display unit), a storage 27, a network interface unit 28, and a bus 29 connecting those units.

The ROM 22 stores programs for executing various types of processing. Connected to the interface unit 25 is a controller 30. The controller 30 includes various buttons and a stick so that various inputs made by the user can be accepted.

Further, the controller 30 includes a built-in acceleration sensor or tilt sensor, and by the user tilting or swinging the controller 30, an instruction to the controller 30 can be accepted.

The controller 30 also includes a vibration unit that causes a vibration by a vibration motor, for example.

In response to an instruction from the CPU 21, the vibration unit can cause a vibration by various frequencies, intensities, durations, counts, and the like.

Connected to the network interface unit 28 is the network 300. As the output unit 26, a liquid crystal display, an EL (Electro Luminescence) display, a plasma display, or the like is applied for image display. As the storage 27, a magnetic disk typified by an HDD (Hard Disk Drive), a semiconductor memory, an optical disc, or the like is applied.

The CPU 21 develops, in the RAM 23, a program corresponding to an instruction from the operation input unit 24 out of a plurality of programs stored in the ROM 22, the storage 27, and the like and appropriately controls the output unit 26 and the storage 27 according to the developed program.

The CPU 21 realizes various functional blocks to be described later. The CPU 21 executes the programs stored in the ROM 22, the storage 27, and the like and controls the members described above as necessary. With this structure, the viewer computer 500 can realize the various functional blocks and cause the members described above to operate as the viewer computer 500.

### (Structure of Image Management Server 400)

Next, a hardware structure of the image management server 400 will be described.

The hardware structure of the image management server 400 is basically the same as that of the viewer computer 500 except that the controller 30 is not connected to the interface unit 25. Therefore, detailed descriptions thereof will be omitted.

### (Functional Blocks of Image Management Server 400)

Next, functional blocks of the image management server 400 will be described. A main function of the image management server 400 is to provide a pathological image in response to a request from the viewer computer 500.

A second function is to store an annotation that a pathologist adds to a specific position of a pathological image on a viewer.

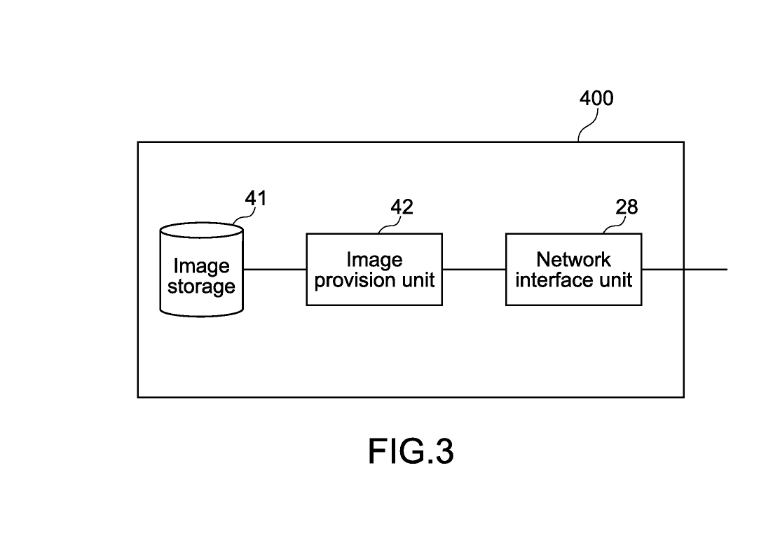

FIG. 3 is a functional block diagram of the image management server 400.

The image management server 400 includes functional blocks of an image storage 41 and an image provision unit 42.

The image storage 41 stores a pathological image divided into tiles and compressed to a JPEG image. The stored pathological image is provided to the viewer computer 500 via the image provision unit 42 in response to a request from the viewer computer 500. The image storage 41 also stores an annotation that the user adds to a pathological image using a viewer on the viewer computer 500.

The image provision unit 42 acquires, from the image storage 41, a pathological image (including annotation) corresponding to an image request transmitted from the viewer computer 500 via the network 300 and transmits the pathological image to the viewer computer 500 via the network 300.

It should be noted that since the image management server 400 and the viewer computer 500 constitute a client-server system, the decision on which function is to be imparted to the client side and which function is to be imparted to the server side is a design matter. Therefore, where to execute the functional blocks is not limited to the image management server 400 described above, and the functional blocks may be executed by the viewer computer 500 on the client side.

### (Functional Blocks of Viewer Computer 500)

Next, functional blocks of the viewer computer 500 will be described. A main function of the viewer computer 500 is to accept an operation instruction from a pathologist as a user, acquire a relevant pathological image (including annotation) from the image management server 400, and display the pathological image to the user. A second function is to notify, in displaying a pathological image, the user of an annotation when it appears on a screen of the viewer computer 500 by vibrating the controller 30.

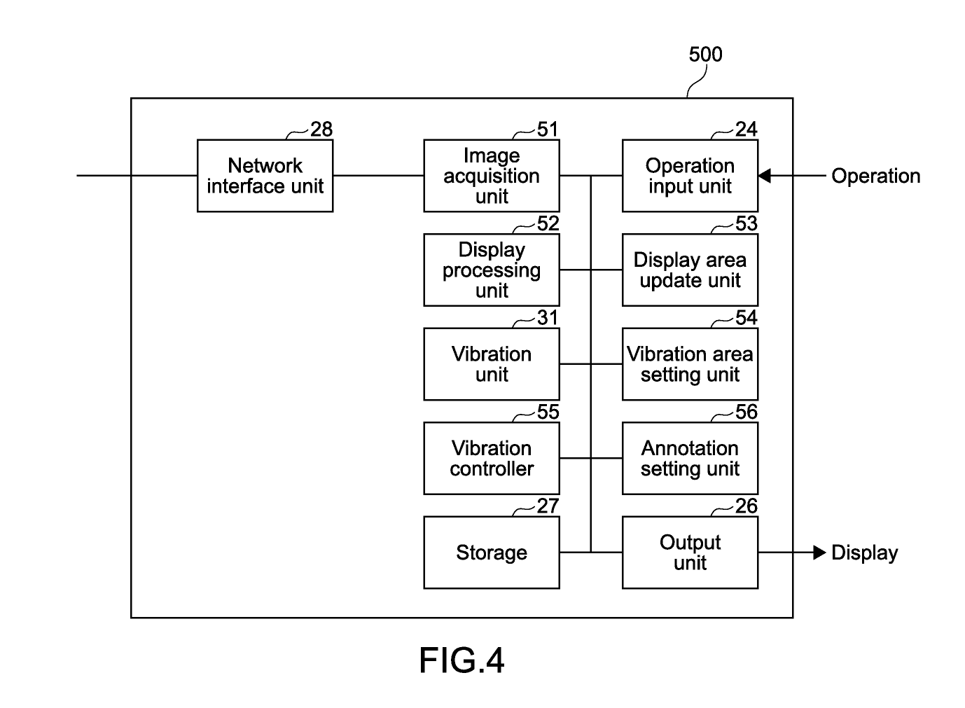

FIG. 4 is a functional block diagram of the viewer computer 500.

The viewer computer 500 includes functional blocks of an image acquisition unit 51, a display processing unit 52 (display processing unit), a display area update unit 53 (update unit), a vibration area setting unit 54 (setting unit), a vibration controller 55 (controller), and an annotation setting unit 56 (annotation setting unit).

The image acquisition unit 51 acquires a pathological image corresponding to an instruction from the pathologist as the user, that has been input from the operation input unit 24, from the image management server 400 via the network 300. The acquired pathological image is presented to the user via the output unit 26 after being processed by the display processing unit 52.

The display processing unit 52 carries out processing of outputting at least a part of the pathological image to the output unit 26 in correspondence with a display area on the screen of the viewer computer 500.

In response to a user operation of pan, zoom, and the like that has been accepted via the operation input unit 24, the display area update unit 53 carries out processing of moving the display area and updating the pathological image displayed on the screen of the viewer.

The vibration area setting unit 54 sets a vibration area to vibrate the vibration unit 31 on the pathological image. The vibration area may be set based on information on a position of an annotation stored in the storage 27, or the user may directly set the vibration area by designating a range.

The vibration controller 55 checks a positional relationship between the display area on the screen of the viewer computer 500 and the vibration area set on the pathological image and causes the vibration unit 31 to vibrate at a given intensity, length, count, frequency when the positional relationship satisfies a predetermined relationship (to be described later).

The annotation setting unit 56 stores, when the user is observing a specific position of the pathological image at a specific display magnification, the annotation added by the user together with the pathological image. The added annotation is transmitted back to the image management server 400 via the network 300 and stored in the image storage 41 together with the pathological image.

Further, the annotation setting unit 56 is capable of selecting whether to cause an area set when setting an annotation to vibrate as the vibration area based on a user instruction. It should be noted that information recorded as an attribute of the annotation when setting the annotation is, for example, a position, width, height of the annotation, a display magnification used when setting the annotation, or a presence of a vibration when the area of the annotation is rectangular.

Heretofore, the functional blocks of the viewer computer 500 have been described. It should be noted that since the viewer computer 500 and the image management server 400 constitute the client-server system, the decision on which function is to be imparted to the client side and which function is to be imparted to the server side is a design matter. Therefore, where to execute the functional blocks is not limited to the viewer computer 500 described above, and the functional blocks may be executed by the image management server 400 on the server side.

### (Positional Relationship Between Vibration Area and Display Area and Vibration)

Next, descriptions will be given on an example of a vibration pattern for vibrating the vibration unit in a case where the positional relationship between the vibration area and the display area is in a specific state.

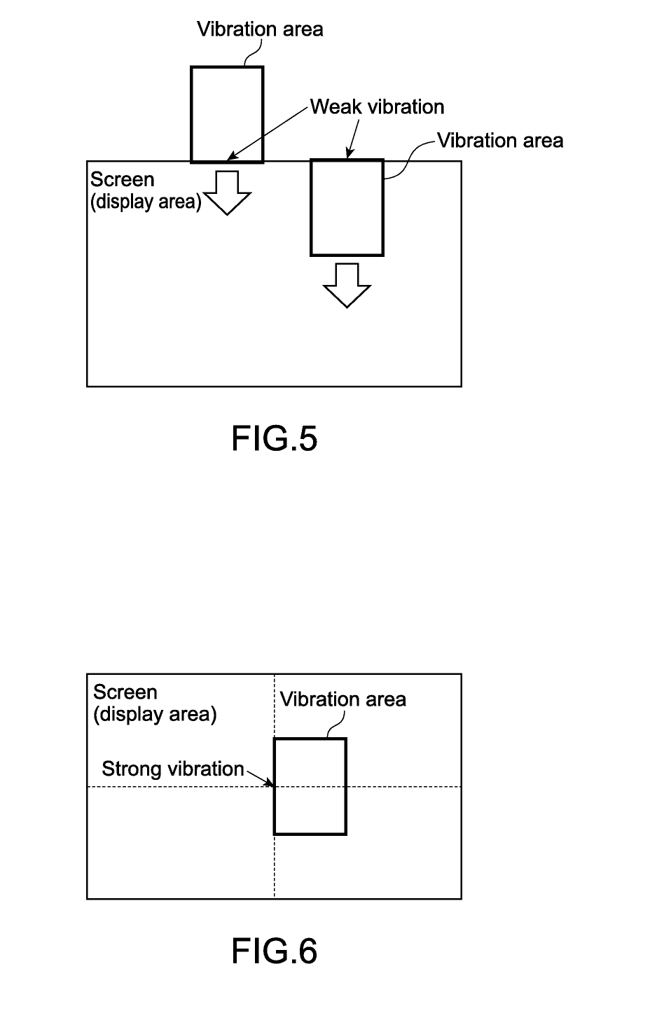

FIG. 5 is a diagram showing a state where a rectangular vibration area enters a screen (display area) of the viewer computer 500 from above by a pan operation of the user. In the example shown in the figure, the vibration unit 31 vibrates weakly when a lower side of the vibration area comes into contact with (overlaps) a boundary of the display area. The vibration unit 31 vibrates weakly also when an upper side of the vibration area comes into contact with the boundary of the display area.

It should be noted that although a short vibration is caused only when the upper or lower side of the vibration area comes into contact with the boundary of the display area in this example, a weak vibration may continuously be caused while the vibration area and the display area overlap each other.

FIG. 6 is a diagram showing a state where the vibration area moving from the right-hand side of the screen comes into contact with (overlaps) a center point of the screen (display area) by a pan operation of the user. In this state, the vibration unit 31 vibrates strongly, for example.

It should be noted that a short vibration may be caused only when the center point of the display area is in contact with the vibration area as described above, and a continuous vibration may be caused while the center point of the display area is included in the vibration area.

Furthermore, it is also possible for the vibration to start weakly at the time the vibration area enters the display area, gradually become stronger as the vibration area approaches the center point of the display area, and vibrate with a largest intensity when the vibration area overlaps the center point of the display area.

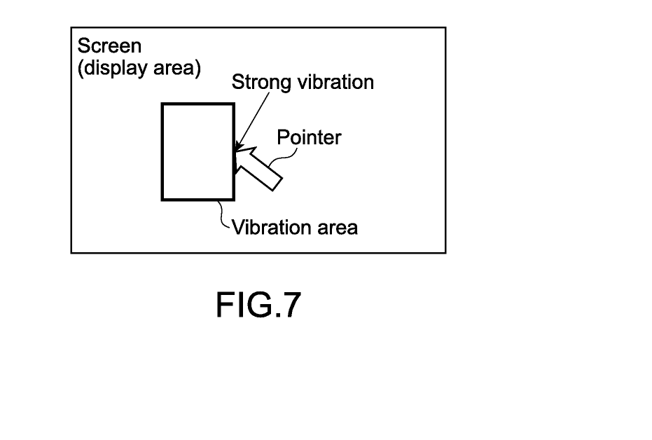

FIG. 7 is a diagram showing a state where a pointer of the viewer of the viewer computer 500 comes into contact with the vibration area. In this state, the vibration unit 31 vibrates strongly, for example.

It should be noted that a vibration may be caused only for a short period of time when the pointer comes into contact with the vibration area, and a continuous vibration may be caused while the pointer is inside the vibration area.

### (Display Magnification and Vibration)

Next, descriptions will be given on an example of a display magnification of a pathological image on the screen of the viewer and a vibration pattern for vibrating the vibration unit.

In general, when looking at an annotation set in a pathological image, it is desirable to observe the pathological image using a display magnification used when setting the annotation. Therefore, in setting an annotation, the annotation setting unit 56 stores a display magnification used when setting the annotation as annotation attribute information. The vibration controller 55 controls the vibration unit 31 to vibrate in a vibration pattern that differs depending on whether the stored display magnification used when setting the annotation is the same as the display magnification used when observing the pathological image again.

As the vibration pattern, for example, a long vibration is caused when the display magnification used when setting the annotation is the same as the display magnification used in the current observation, and a short vibration is caused when the display magnifications differ. It should be noted that the trigger for causing the vibration unit 31 to vibrate is the positional relationship between the display area and the vibration area satisfying a certain relationship as described above.

### (Notification on Presence of Annotation Using Vibration)

Next, descriptions will be given on an example of notifying the user of whether there is an annotation within the display area using a vibration. Here, as a presupposition, the vibration count is 2 when there is a vibration area of the annotation in the display area, and the vibration count is 1 when there is no vibration area of the annotation in the display area.

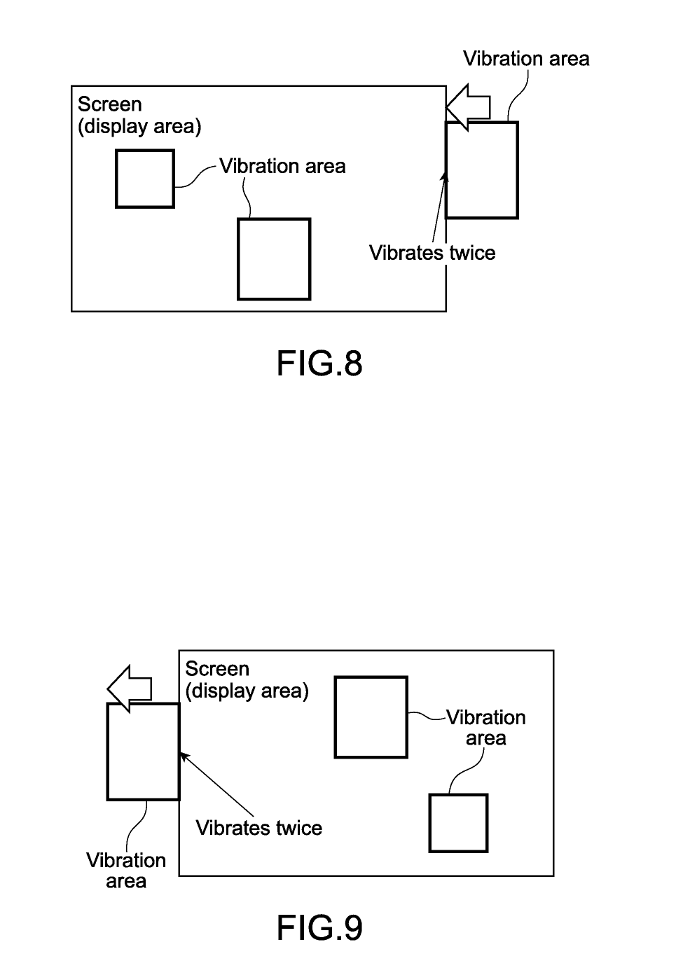

FIG. 8 is a diagram showing an example where, in a state where the vibration area already exists in the display area, a vibration is caused twice due to the vibration area newly entering the display area. Further, FIG. 9 is a diagram showing an example where, when one vibration area moves out of the display area, the vibration is caused twice since there are still other vibration areas left in the display area.

As described above, by notifying the user of the presence of other vibration areas in the display area when a vibration is caused as the positional relationship between the display area and the vibration area satisfies a certain relationship, the user can grasp whether there are other annotations in the display area.

### (Notification of Number of Annotations Using Vibration (Modified Example))

Next, descriptions will be given on an example of notifying, using a vibration, the user of the number of annotations present in the display area. In causing a vibration when the positional relationship between the display area and the vibration area satisfies a certain relationship, the vibration controller 55 may notify the user of the number of vibration areas present in the display area using the vibration. FIGS. 8 and 9 will be described as an example.

In the state shown in FIG. 8, two vibration areas are present in the display area, and for notifying the number of vibration areas, the vibration is caused twice when the vibration area newly enters the display area. Moreover, in the state shown in FIG. 9, when one vibration area moves out of the display area, the vibration is caused twice since there are still two vibration areas left in the display area.

As described above, by notifying the user of the number of vibration areas present in the display area when causing a vibration as the positional relationship between the display area and the vibration area satisfies a certain relationship, the user can grasp the number of annotations present in the display area.

### ((Overall) Flow of Processing)

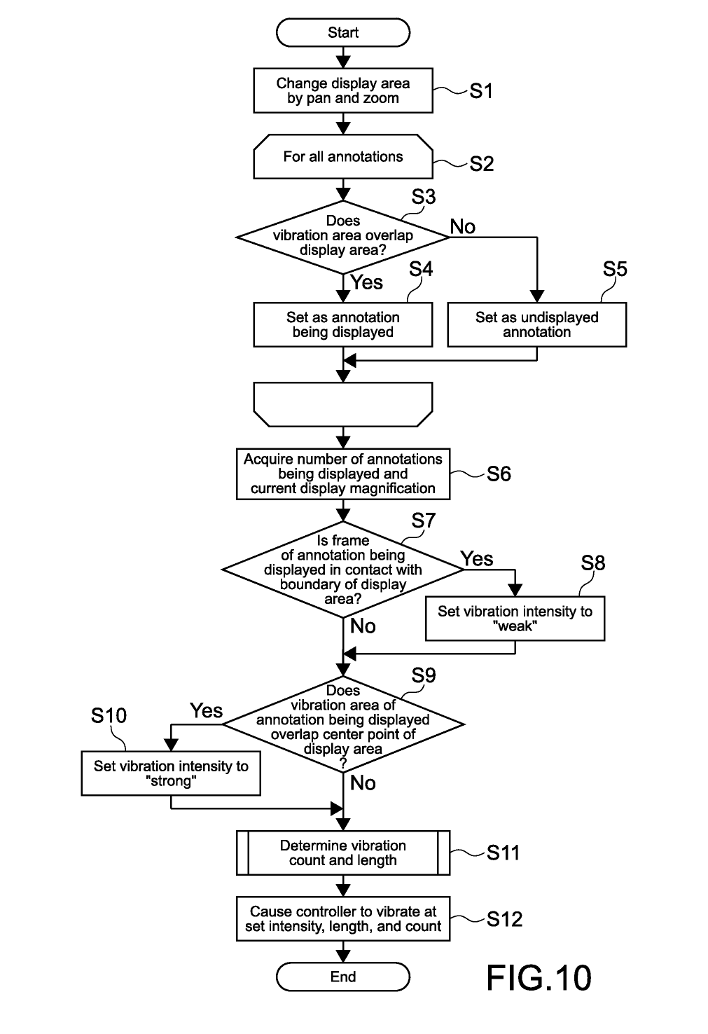

Next, an overall flow of processing will be described. FIG. 10 is a flowchart for explaining the overall flow of processing.

First, the display area update unit 53 changes a position of the display area according to pan and zoom operations input by the user via the operation input unit 24 (Step S1).

Next, for all annotations (Step S2), the vibration controller 55 judges whether a vibration area of the annotation overlaps the display area (Step S3).

When the vibration area and the display area overlap (Yes in Step S3), the vibration controller 55 sets a flag expressing “being displayed” to the relevant annotation (Step S4).

When the vibration area and the display area do not overlap (No in Step S3), the vibration controller 55 sets a flag expressing “undisplayed” to the relevant annotation (Step S5).

Subsequently, the vibration controller 55 acquires the number of annotations recorded as “being displayed” and the current display magnification (Step S6).

Then, the vibration controller 55 judges whether a frame line of the vibration area of the annotation being displayed is in contact with (overlaps) the boundary of the display area (Step S7), and when judged Yes (Yes in Step S7), the vibration controller 55 sets the vibration intensity to “weak” (Step S8).

After that, the vibration controller 55 judges whether the vibration area of the annotation being displayed is in contact with (overlaps) the center point of the display area (Step S9), and when judged Yes (Yes in Step S9), the vibration controller 55 sets the vibration intensity to “strong” (Step S10).

Next, the vibration controller 55 determines the vibration count and length (Step S11).

Finally, the vibration controller 55 causes the vibration unit 31 to vibrate with the set vibration intensity, length, and count (Step S12).

The overall flow of the processing of causing the vibration unit 31 to vibrate based on the positional relationship between the display area and the vibration area has been described heretofore.

### (Flow of Processing (Determination of Vibration Count and Length))

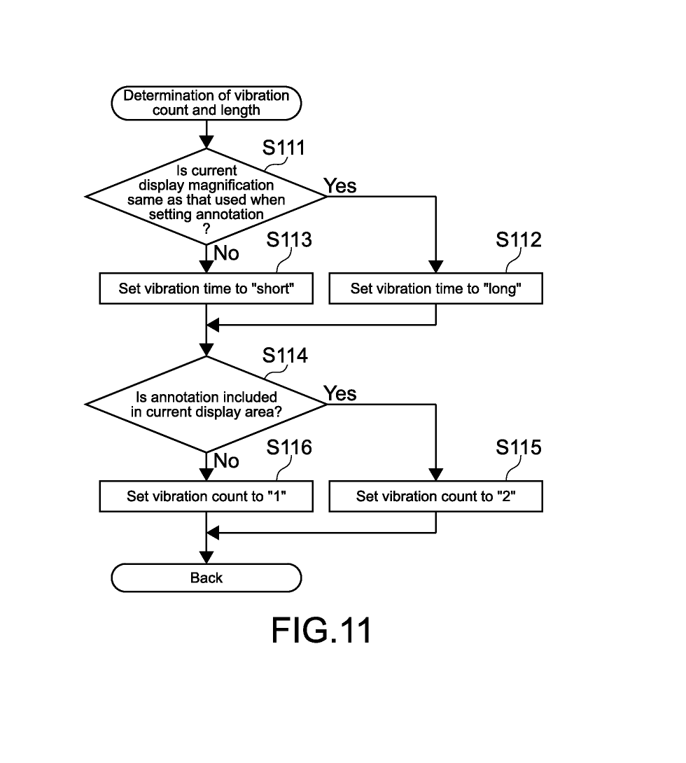

Next, of the processing of causing the vibration unit 31 to vibrate, a flow of processing of determining the vibration count and length based on the positional relationship between the display area and the vibration area will be described. FIG. 11 is a flowchart showing a flow of the processing of determining the vibration count and length.

First, the vibration controller 55 judges whether the display magnification used in the current observation of the pathological image by the user is the same as the stored display magnification used when setting an annotation (Step S111).

When the display magnifications are the same (Yes in Step S111), the vibration controller 55 sets the vibration length to “long” (Step S112). When the display magnifications differ (No in Step S111), the vibration controller 55 sets the vibration length to “short” (Step S113).

Then, the vibration controller 55 judges whether an annotation is included in the current display area (Step S114).

When an annotation is included (Yes in Step S114), the vibration controller 55 sets the vibration count to 2 (Step S115). When no annotation is included (No in Step S114), the vibration controller 55 sets the vibration count to 1 (Step S116).

Described above is the flow of the processing of determining the vibration count and length.

### (Effect of Present Disclosure)

In the present disclosure, in observing a pathological image using the viewer, information that depends on a tactile sense caused by a vibration is used in addition to visual information used from the past so as not to overlook an annotation set on the pathological image. As a result, the possibility of overlooking an annotation is reduced.

Further, as in a manner mode in cellular phones, even when sounds are prohibited, information can be notified to only the user operating the controller without causing someone a trouble by using the vibration.

By notifying the user of the number of annotations displayed in the display area (screen) of the viewer as the vibration count, the user can grasp that there are other annotations to be focused on in the display area.

Regarding the display magnification, by differentiating the vibration pattern depending on whether the display magnification used when setting the annotation is the same as the display magnification used in the observation by the user, the user can grasp the display magnification used when setting the annotation.

(Cooperation with Automatic Diagnosis System)

In the descriptions above, the vibration area that is to vibrate is set based on the setting of an annotation made by the user. As another vibration area setting method, there is a method of cooperating with an automatic diagnosis system.

First, a pathological image is subjected to the automatic diagnosis system, and a part considered to be affected by cancer is presented by this system, for example. Next, in a viewer computer that uses the present disclosure, a vibration area is set to the part considered to be affected by cancer. With this structure, the possibility of overlooking the part determined as questionable by the automatic diagnosis system in a definite diagnosis is reduced.

### Second Embodiment

In a second embodiment, functional blocks of the viewer computer 500 and the like are the same as those of the first embodiment unless specifically stated otherwise.

### (Outline of Present Disclosure)

First, an outline of the second embodiment of the present disclosure will be described.

In the first embodiment, the vibration unit 31 vibrates when the vibration area of the annotation preset on the pathological image by the user is displayed in the screen (display area). The vibration pattern in this case is a predetermined pattern considering the system.

In contrast, in the second embodiment, a vibration area is set regardless of the annotation so that the vibration can be caused at a desired position of the user in a desired vibration pattern.

The second embodiment assumes to be mainly used in an image diagnosis education. To enable a learner to find an affected part by him/herself, a vibration area preset on a pathological image by a trainer is undisplayed on the image. By the learner moving the pointer of the viewer so that it overlaps the vibration area for judging whether the part is the correct affected part, a vibration is caused, and thus the learner can grasp that the part is the part intended by the trainer.

### (Edit Mode)

Next, a vibration area edit mode will be described.

The feature of the second embodiment of the present disclosure is that there is no annotation setting unit as the functional block of the viewer computer 500, and instead, a vibration area setting unit specifically sets a vibration area based on a user instruction.

By the user invoking a vibration area edit mode of the viewer, the user (trainer) can set a vibration area while designating a position and size thereof on a pathological image.

### (Vibration Area)

Next, a specific example of the vibration area will be described.

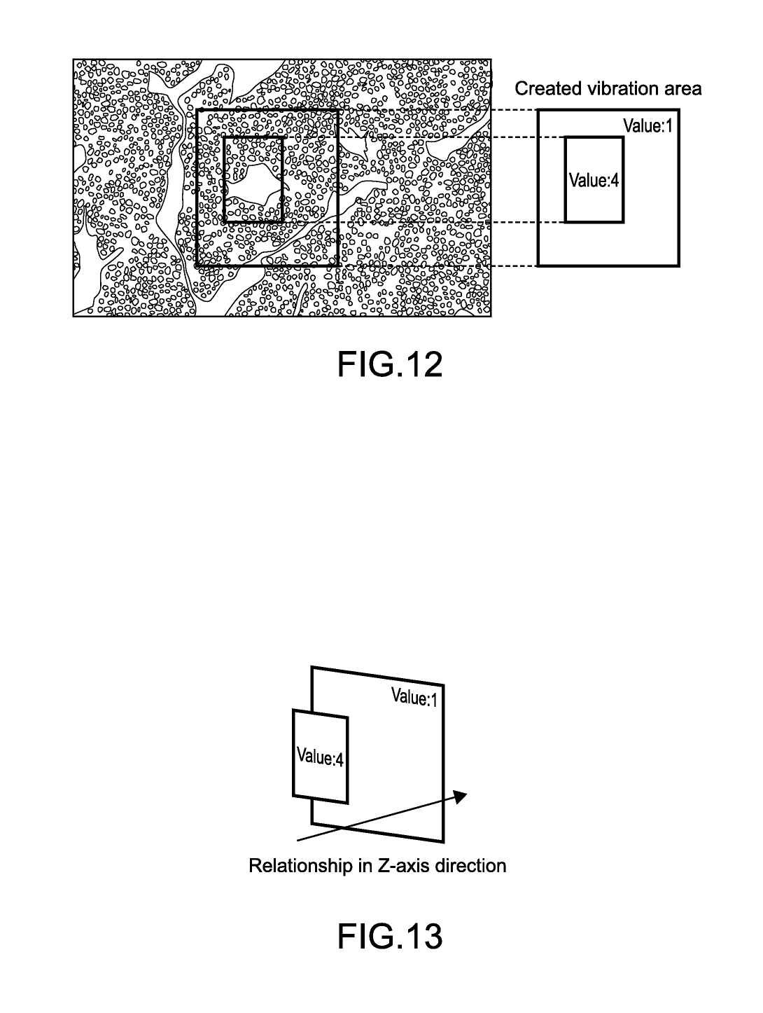

FIG. 12 is a diagram showing an example of a vibration area created in the vibration area edit mode. In the area described as “value: 1” in the figure, a vibration of an intensity 1 is caused when the pointer overlaps that area. In the area described as “value: 4”, a vibration of an intensity 4 (stronger than 1) is caused similarly.

As shown in FIG. 13, an anteroposterior relationship in a Z-axis direction is defined for the vibration areas. In this regard, after setting the rectangular area at which the vibration intensity first becomes 1 as the vibration area, the user (trainer) sets, as the vibration area, a smaller rectangular area at which the vibration intensity becomes 4 within that area (front in Z-axis direction).

It should be noted that although the vibration area is rectangular in this example, the shape of the vibration area is not limited to a rectangle and may be any shape as long as an area can be designated.

### (Positional Relationship for Causing Vibration)

Next, a positional relationship between the pointer of the viewer and the vibration area for causing a vibration will be described.

Basically, as the pointer enters the vibration area by a user operation, the vibration controller 55 causes the vibration unit 31 to vibrate using a vibration intensity set for the vibration area.

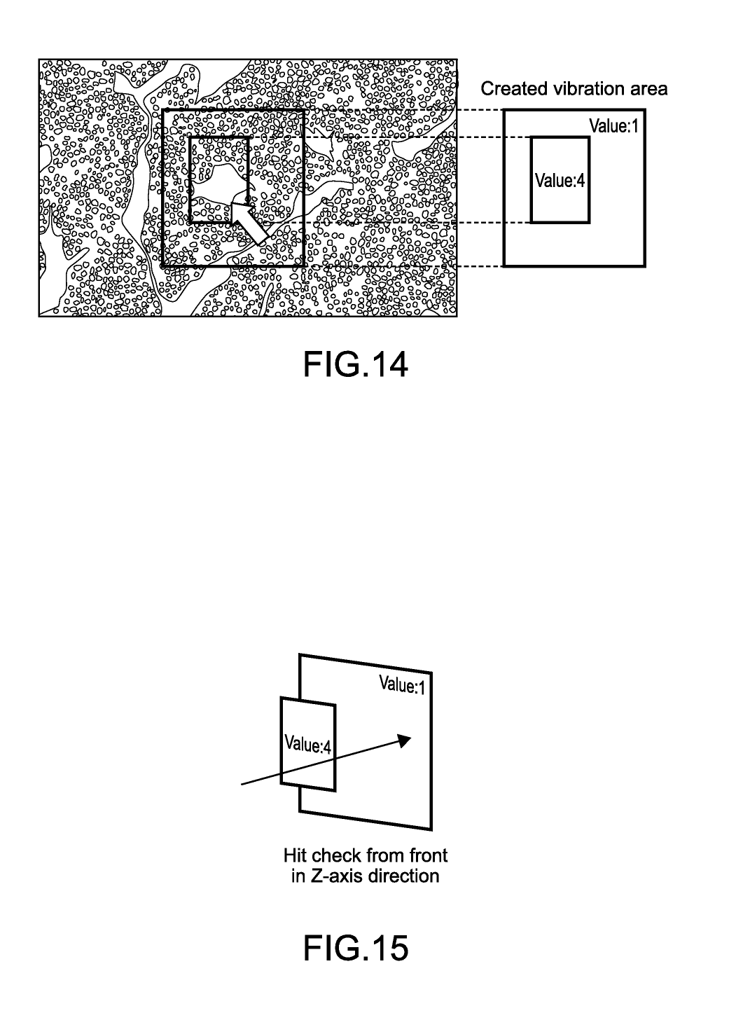

FIG. 14 is a diagram showing a state where a vibration having a vibration intensity 4 is caused due to the pointer overlapping the vibration area with the vibration intensity 4.

It should be noted that although the pointer is also in the vibration area with the vibration intensity 1 at the position of the pointer shown in FIG. 14, whether the position of the pointer is included in a range from the vibration area in front in the Z-axis direction is checked as shown in FIG. 15. Since the intensity designation of the vibration area that the pointer first enters is prioritized, the vibration is caused using the vibration intensity 4.

### (Flow of Processing of Causing Controller to Vibrate)

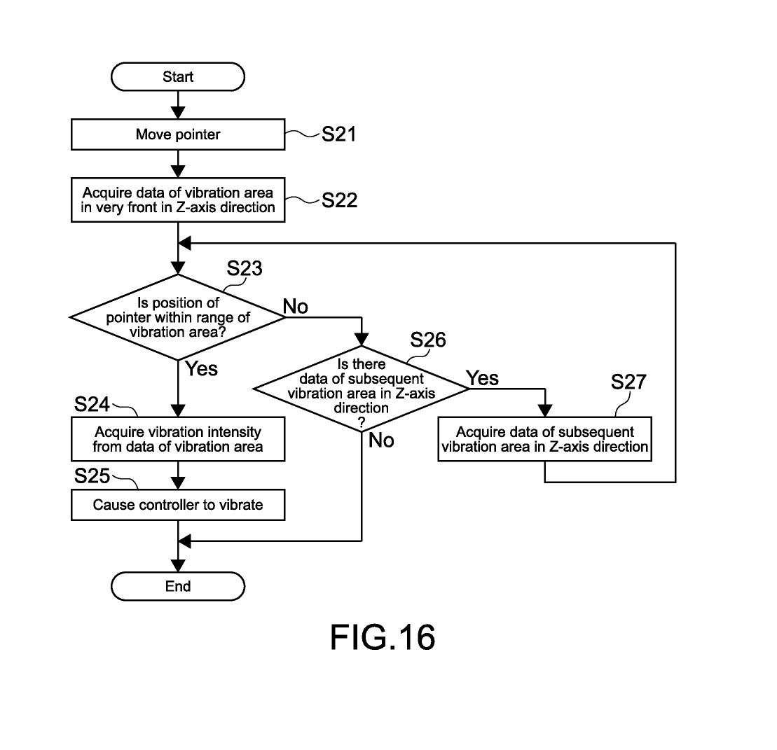

Next, a flow of processing of causing the controller 30 to vibrate will be described. FIG. 16 is a flowchart for explaining the flow of the processing of causing the controller 30 to vibrate.

First, the display processing unit 52 moves the pointer of the viewer based on a user operation (Step S21).

Then, the vibration controller 55 acquires data on the vibration area located in the very front (upper side) in the Z-axis direction at the new position of the pointer (Step S22).

Next, the vibration controller 55 judges whether the position of the pointer is within the range of the vibration area for which the data has been acquired in Step S22 (Step S23).

When the position of the pointer is within the range of the vibration area (Yes in Step S23), the vibration controller 55 extracts and acquires a vibration intensity from the data of the vibration area (Step S24).

Subsequently, the vibration controller 55 causes the vibration unit 31 of the controller 30 to vibrate using the acquired vibration intensity (Step S25).

It should be noted that when the position of the pointer is outside the range of the vibration area for which the data has been acquired in Step S23 (No in Step S23), the vibration controller 55 judges whether there is data on a vibration area subsequent to the current one in the Z-axis direction (Step S26).

When there is data on the subsequent vibration area (Yes in Step S26), the vibration controller 55 acquires data on the vibration area (Step S27) and returns to Step S23 to continue the processing.

The flow of the processing of causing the controller 30 to vibrate has been described heretofore.

### (Other Structures of Present Disclosure)

The present disclosure may also take the following structures.

(1) An information processing apparatus, including:

a display processing unit configured to display, on a display unit, at least a part of a pathological image as a display area;

an update unit configured to accept an instruction from a user to move the display area on the pathological image and update a position of the display area displayed on the update unit;

a vibration unit capable of causing a vibration;

a setting unit configured to set a vibration area to cause a vibration by the vibration unit on the pathological image; and

a controller configured to control the vibration unit to vibrate when a positional relationship between the set vibration area and the display area satisfies a predetermined relationship.

(2) The information processing apparatus according to (1) above, further including:

an annotation setting unit configured to set an annotation in at least a partial area of the pathological image in response to an instruction from the user; and

a storage configured to store positional information of an area of the set annotation,

in which the setting unit sets the vibration area based on the stored positional information.

(3) The information processing apparatus according to (1) or (2) above,

in which the positional relationship is a positional relationship in which a position that matches between the vibration area and the display area exists.

(4) The information processing apparatus according to (1) or (2) above,

in which the positional relationship is a positional relationship in which the display area comes into contact with the vibration area by the movement of the display area.

(5) The information processing apparatus according to (1) or (2) above,

in which the controller controls the vibration unit to vibrate while differentiating a vibration pattern between a time an event in which a position that matches between the vibration area and the display area exists occurs and a time an event in which the vibration area includes a center point of the display area occurs.

(6) The information processing apparatus according to any one of (1) to (5) above,

in which the controller controls, when controlling the vibration unit to vibrate, the vibration unit to vibrate in a vibration pattern corresponding to the number of vibration areas set within a range of the pathological image displayed in the display area.

(7) The information processing apparatus according to (6) above,

in which the controller controls the vibration unit to vibrate in vibration patterns having different vibration counts, the vibration patterns corresponding to the number of vibration areas.

(8) The information processing apparatus according to (2) above,

in which the annotation setting unit stores information on a display magnification of the pathological image used when setting the annotation in the storage in association with the positional information, and

in which the controller controls, when controlling the vibration unit to vibrate, the vibration unit to vibrate in a vibration pattern that differs depending on whether the stored information on the display magnification is the same as a display magnification used when the pathological image is displayed in the display area.

(9) The information processing apparatus according to (1) above,

in which the setting unit sets the vibration area based on an input from the user.

(10) An information processing method, including:

displaying on a display unit, by a display processing unit, at least a part of a pathological image as a display area;

accepting, by an update unit, an instruction from a user to move the display area on the pathological image and updating a position of the display area displayed on the update unit;

causing a vibration by a vibration unit;

setting, by a setting unit, a vibration area to cause a vibration by the vibration unit on the pathological image; and

controlling, by a controller, the vibration unit to vibrate when a positional relationship between the set vibration area and the display area satisfies a predetermined relationship.

(11) An information processing program that causes a computer including a vibration unit capable of causing a vibration to operate as:

a display processing unit configured to display, on a display unit, at least a part of a pathological image as a display area;

an update unit configured to accept an instruction from a user to move the display area on the pathological image and update a position of the display area displayed on the update unit;

a setting unit configured to set a vibration area to cause the vibration by the vibration unit on the pathological image; and

a controller configured to control the vibration unit to vibrate when a positional relationship between the set vibration area and the display area satisfies a predetermined relationship.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a display processing unit configured to display, on a display unit, at least a part of a pathological image as a display area;
an update unit configured to accept an instruction from a user to move the display area on the pathological image and update a position of the display area displayed on the update unit;
a vibration unit capable of causing a vibration;
a setting unit configured to set a vibration area to cause a vibration by the vibration unit on the pathological image; and
a controller configured to control the vibration unit to vibrate when a positional relationship between the set vibration area and the display area satisfies a predetermined relationship.

2. The information processing apparatus according to claim 1, further comprising:
an annotation setting unit configured to set an annotation in at least a partial area of the pathological image in response to an instruction from the user; and
a storage configured to store positional information of an area of the set annotation,
wherein the setting unit sets the vibration area based on the stored positional information.

3. The information processing apparatus according to claim 2,
wherein the positional relationship is a positional relationship in which a position that matches between the vibration area and the display area exists.

4. The information processing apparatus according to claim 2,
wherein the positional relationship is a positional relationship in which the display area comes into contact with the vibration area by the movement of the display area.

5. The information processing apparatus according to claim 2,
wherein the controller controls the vibration unit to vibrate while differentiating a vibration pattern between a time an event in which a position that matches between the vibration area and the display area exists occurs and a time an event in which the vibration area includes a center point of the display area occurs.

6. The information processing apparatus according to claim 5,
wherein the controller controls, when controlling the vibration unit to vibrate, the vibration unit to vibrate in a vibration pattern corresponding to the number of vibration areas set within a range of the pathological image displayed in the display area.

7. The information processing apparatus according to claim 6,
wherein the controller controls the vibration unit to vibrate in vibration patterns having different vibration counts, the vibration patterns corresponding to the number of vibration areas.

8. The information processing apparatus according to claim 2,
wherein the annotation setting unit stores information on a display magnification of the pathological image used when setting the annotation in the storage in association with the positional information, and
wherein the controller controls, when controlling the vibration unit to vibrate, the vibration unit to vibrate in a vibration pattern that differs depending on whether the stored information on the display magnification is the same as a display magnification used when the pathological image is displayed in the display area.

9. The information processing apparatus according to claim 1,
wherein the setting unit sets the vibration area based on an input from the user.

10. An information processing method, comprising:
displaying on a display unit, by a display processing unit, at least a part of a pathological image as a display area;
accepting, by an update unit, an instruction from a user to move the display area on the pathological image and updating a position of the display area displayed on the update unit;
causing a vibration by a vibration unit;
setting, by a setting unit, a vibration area to cause a vibration by the vibration unit on the pathological image; and
controlling, by a controller, the vibration unit to vibrate when a positional relationship between the set vibration area and the display area satisfies a predetermined relationship.

11. An information processing program that causes a computer including a vibration unit capable of causing a vibration to operate as:
a display processing unit configured to display, on a display unit, at least a part of a pathological image as a display area;
an update unit configured to accept an instruction from a user to move the display area on the pathological image and update a position of the display area displayed on the update unit;
a setting unit configured to set a vibration area to cause the vibration by the vibration unit on the pathological image; and
a controller configured to control the vibration unit to vibrate when a positional relationship between the set vibration area and the display area satisfies a predetermined relationship.
